(19) United States
(12) Patent Application Publication
(10) Pub. No.: US 2020/0167416 A1
(43) Pub. Date: May 28, 2020

(54) SYSTEM AND METHOD FOR GENERATING DYNAMIC TEMPLATES

(71) Applicant: Zipwhip, Inc., Seattle, WA (US)

(72) Inventors: Thomas Jacob Michael Grajewski, Seattle, WA (US); James Lapic, Kirkland, WA (US); Carl Derline, Seattle, WA (US)

(21) Appl. No.: 16/201,682

(22) Filed: Nov. 27, 2018

(51) Int. Cl. G06F 17/24; H04L 12/58; H04W 4/14

(52) U.S. Cl. CPC G06F 17/248; H04W 4/14; H04L 51/18

(57) ABSTRACT

A method of generating a message body including receiving data points from a plurality of sources. The plurality of sources determines the dynamic fields presented on a graphical user interface that may be utilized to generate a message body. The dynamic fields are then enriched by the data points. If no data point is available, the graphical user interface notifies the user and inhibits the user from generating a text message from the message body. The method may also utilize dynamic templates to generate a message body. These dynamic templates are enriched when utilized by the graphical user interface. A text message generated is sent to an SMS server.

### BACKGROUND

A user may utilize graphical user interfaces to interact with customers. However, utilizing conventional means to interact with the customer, such as inputting text alone, is inefficient. Many times, the user queries customers about similar topics. In other instances, the user may want to include information in the communication that may not be readily available to the user but may be stored easily. Finally, entering familiar information, such as the user's name, by text input may be inefficient.

### BRIEF SUMMARY

The present method enables a user to utilize a graphical user interface to efficiently add text to a message body. The text may be unknown to the user or time-consuming to enter. The graphical user interface utilizes dynamic fields that may be selected and are subsequently substituted with a corresponding data point. A dynamic field without a corresponding data point may display an error on the graphical user interface, which may then inhibit a text message from being generated from the partially-enriched message body. The method also utilizes dynamic templates that may be generated and selected. The dynamic templates combine both text and dynamic fields. Once selected, the dynamic template forms the message body and is enriched by the data points corresponding to the dynamic fields.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a dynamic messaging system 100.

FIG. 2 illustrates an embodiment of a dynamic messaging method 200.

FIG. 3 illustrates an embodiment of a dynamic template system 300.

FIG. 4 illustrates an embodiment of a dynamic templating method 400.

FIG. 5 illustrates an embodiment of a graphical user interface 500.

FIG. 6 illustrates an embodiment of a graphical user interface 500.

FIG. 7 illustrates an embodiment of a graphical user interface 500.

FIG. 8 illustrates an embodiment of a graphical user interface 500.

FIG. 9 illustrates an embodiment of a graphical user interface 500.

FIG. 10 illustrates an embodiment of a graphical user interface 500.

FIG. 11 illustrates an embodiment of a graphical user interface 500.

FIG. 12 illustrates an embodiment of a graphical user interface 500.

FIG. 13 is an example block diagram of a computing device 1300 that may incorporate embodiments of the present invention.

### DETAILED DESCRIPTION

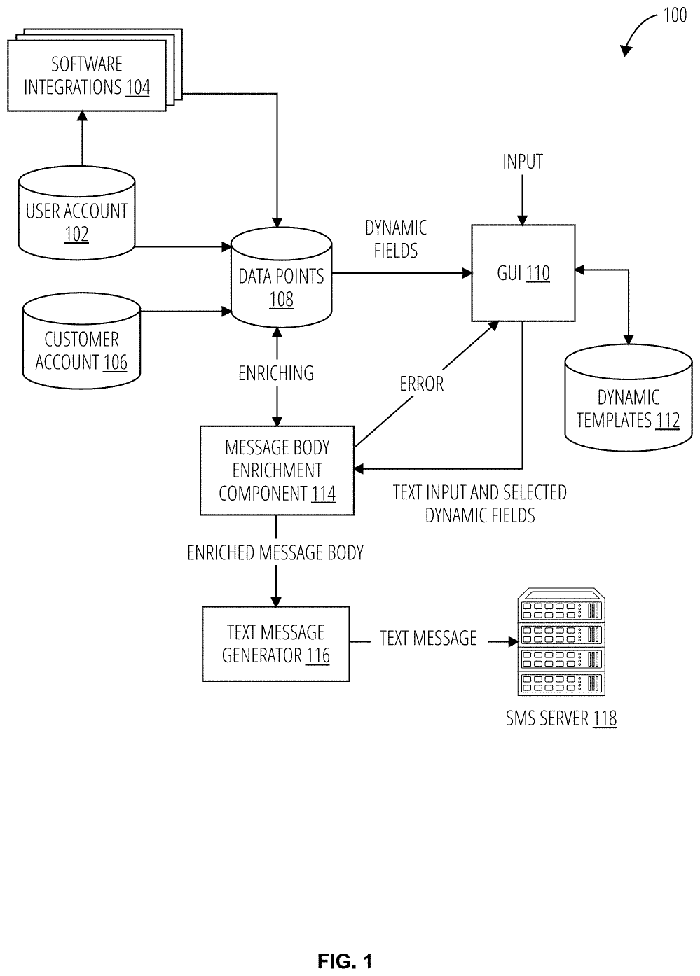

Referring to FIG. 1, a dynamic messaging system 100 comprises a user account 102, software integrations 104, a customer account 106, a data points control memory structure 108, a graphical user interface 110, a dynamic templates control memory structure 112, a message body enrichment component 114, a text message generator 116, and an SMS server 118.

The user account 102 provides data points associated with a user that interfaces with the graphical user interface 110. Each user account 102 may have data points corresponding to their first name, last name, phone number, job title, email, etc. These data points are stored in the data points control memory structure 108. The user account 102 may also be associated with one or more of the software integrations 104. Each user may be associated with the same or different software integrations 104. When the graphical user interface 110 is utilized by a specific user account 102, the user account 102 may send a control signal to the software integrations 104 to send data points to the data points control memory structure 108. The user account 102 may utilize the graphical user interface 110 to contact a customer account 106.

The software integrations 104 may receive a control signal from the user account 102 operating the graphical user interface 110 to send data points to the data points control memory structure 108. The software integrations 104 then sends the data points to the data points control memory structure 108. The software integrations 104 may be software platforms that are interfaced by the user account 102. Exemplary software integrations 104 include Salesforce®, credit transaction services, third party email platforms, etc. The data points associated with the software integrations 104 may include Salesforce® ID, a credit account number, a third-party email address, etc.

The customer account 106 may be contacted by the user account 102 utilizing the graphical user interface 110. The customer account 106 sends data points to the data points control memory structure 108 to be utilized to generate a text message to contact the customer associated with the customer account 106. The data points may correspond to the first name, last name, company, job title, address, etc.

The data points control memory structure 108 receives the data points from the user account 102, the software integrations 104, and the customer account 106 (i.e., the plurality of sources). Each of the plurality of sources is associated with one or more dynamic fields. These dynamic fields are sent to the graphical user interface 110 to be displayed. The dynamic fields may also have associated descriptors, such as [Last Name]. These descriptors may be displayed as part of the dynamic fields on the graphical user interface 110. The data points on the other hand are the specific information associated for the user account 102, the software integrations 104, and the customer account 106. An exemplary data point would be “Smith” for the dynamic field, [Last Name]. Each of the dynamic fields may not have a corresponding data point.

The graphical user interface 110 is configured by the dynamic fields sent from the data points control memory structure 108, as well as by the dynamic templates from the dynamic templates control memory structure 112. The graphical user interface 110 may receive an input. The input may be associated with adding text (a text input), a dynamic field (dynamic field input), or a dynamic template (a dynamic template input) to a message compose box. The dynamic template may add text and dynamic fields. These selected text and dynamic fields are sent to the message body enrichment component 114. The graphical user interface 110 may also include selectors to alter the display of the graphical user interface 110, including to enable receiving further inputs. The graphical user interface 110 may also display indicators, such as to highlight features of the message body. The indicators may include an indication of the placement of text or dynamic fields, indications of dynamic fields that have not been enriched, etc. The graphical user interface 110 may also include a selector to convert the message body into a text message. This selector may not be able to receive an input while the message body is a partially-enriched message body.

The dynamic templates control memory structure 112 stores dynamic templates. The dynamic templates may be pre-determined sets of text and dynamic fields. The dynamic templates control memory structure 112 receives generated dynamic templates from the graphical user interface 110 to be stored. The dynamic templates control memory structure 112 also sends selected dynamic templates to the graphical user interface 110 to be displayed.

The message body enrichment component 114 receives the message body from the graphical user interface 110. The message body may include text and dynamic fields. The message body enrichment component 114 retrieves the corresponding data point for each of the dynamic fields from the data points control memory structure 108. The message body enrichment component 114 may then return an error to the graphical user interface 110 if some of the dynamic fields have no corresponding data point. The graphical user interface 110 may then display a partially-enriched message body that has each corresponding data point substitute for its dynamic field. The dynamic fields without a corresponding data point may be indicated as such by the graphical user interface 110. The message body enrichment component 114 may return the completed message body to the graphical user interface 110 if each dynamic field is substituted. The message body enrichment component 114 may send the enriched message body to the text message generator 116. In some embodiments, the message body enrichment component 114 sends the enriched message body to the text message generator 116 after an input is received by the graphical user interface 110 at a selector to convert the message body (or enriched message body) into a text message (or enriched text message).

The text message generator 116 receives the message body (or enriched message body) from the message body enrichment component 114 and transforms it into a text message (or enriched text message). The text message generator 116 then sends the text message to the SMS server 118. The SMS server 118 may be configured by the text message (e.g., by the metadata of the text message) to send the text message to the customer account 106.

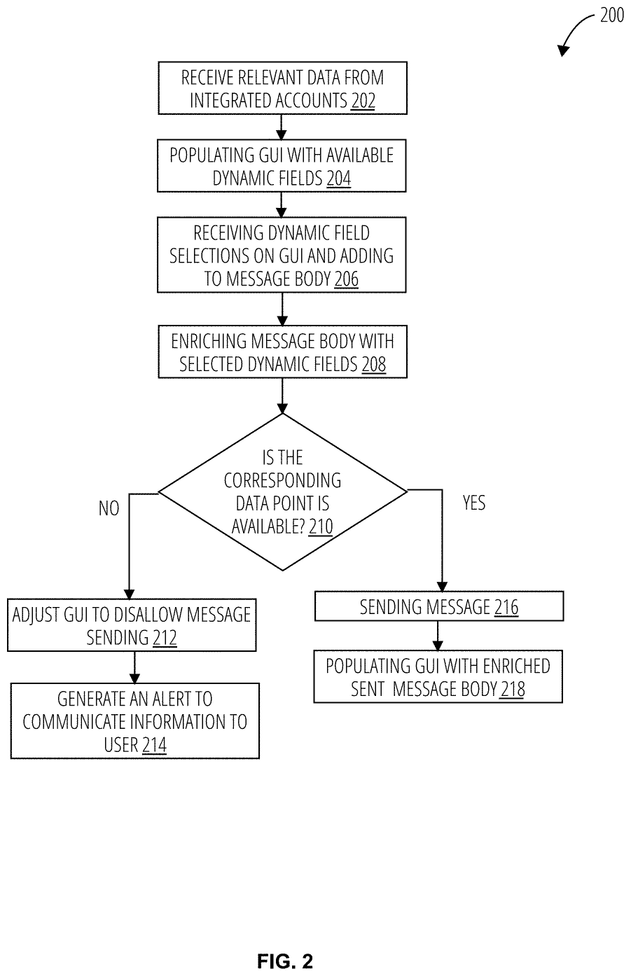

The dynamic messaging system 100 may be operated in accordance with the process depicted in FIG. 2.

Referring to FIG. 2, a dynamic messaging method 200 receives relevant data from integrated accounts (block 202). The integrated account may be from a plurality of sources. The sources, by default, are a user account and a customer account (or the contact account). The plurality of sources may also include software integrations. A graphical user interface is then populated with available dynamic fields (block 204). The available dynamic fields are determined by the plurality of sources available. By default, the available dynamic fields comprise fields for the user account and the customer account (i.e., the default fields). Additional dynamic fields may be populated based on the integrations (i.e., the integration fields). The dynamic fields are populated into a dynamic fields list that is displayed on the graphical user interface. The dynamic fields may be categorized by the source. The dynamic fields may further be prioritized. For example, the dynamic fields related to the user account may be located closest to the message compose box, the dynamic fields related to the customer account may be located on the graphical user interface at an intermediate distance from the message compose box, and the dynamic fields related to the software integrations may be located the furthest from the message compose box. This pre-determined priority may be utilized to make entering a dynamic field input more efficient by locating dynamic fields that may be utilized more often closer to the message compose box. The dynamic messaging method 200 may also utilize a machine learning component to determine the dynamic fields utilized most often by the user associated with the user account, or by a group of users associated with a plurality of user accounts. The dynamic fields utilized most often may be determined by the number of times the dynamic field is enriched, and a counter is utilized to track the number of times enriched. The default fields list may then be prioritized as such.

Dynamic field selections are received on the graphical user interface and added to message body (block 206). The selection may be made by a machine input to a location on the graphical user interface associated with the dynamic field selected. The selection may also be made utilizing audio, visual tracking, touch-screen input, etc. The message body may also include text entered by a text input. Further dynamic fields may be automatically added to the message body based on the previous dynamic field input, as well as current text and dynamic fields in the message body. These further dynamic fields may be determined by machine learning techniques. A likelihood of the additional dynamic field may be determined based on the previous message bodies. If above a particular threshold, the further dynamic field is added. Text may also be similarly added. The message body is enriched with the selected dynamic fields (block 208). Each dynamic field is substituted with a corresponding data point, if available. The dynamic messaging method 200 then determines whether the corresponding data point is available (decision block 210). The corresponding data points may be stored in a data points control memory structure, which receives data points from the plurality of sources. If the corresponding data point is not available, the graphical user interface is adjusted to disallow message sending (block 212). An alert (or error) is generated to communicate information to user (block 214). The alert may include highlighting, bolding, or otherwise altering the dynamic field in the message body on the graphical user interface. The graphical user interface may also include additional text to explain the altered message body. This additional text may be similarly altered.

If the corresponding data point is available, the text message is sent (block 216). In some embodiments, an additional input to the graphical user interface may be utilized prior to sending the text message. In such an embodiment, the graphical user interface may be updated with the updated message body that comprises each dynamic field in the message compose box substituted with text corresponding to the corresponding data point. Once the text message is sent, the graphical user interface is populated with the enriched sent message body (block 218). The text message may also be transmitted to an SMS server. The SMS server may be configured by the text message (e.g., by the metadata of the text message) to send the text message to the customer account.

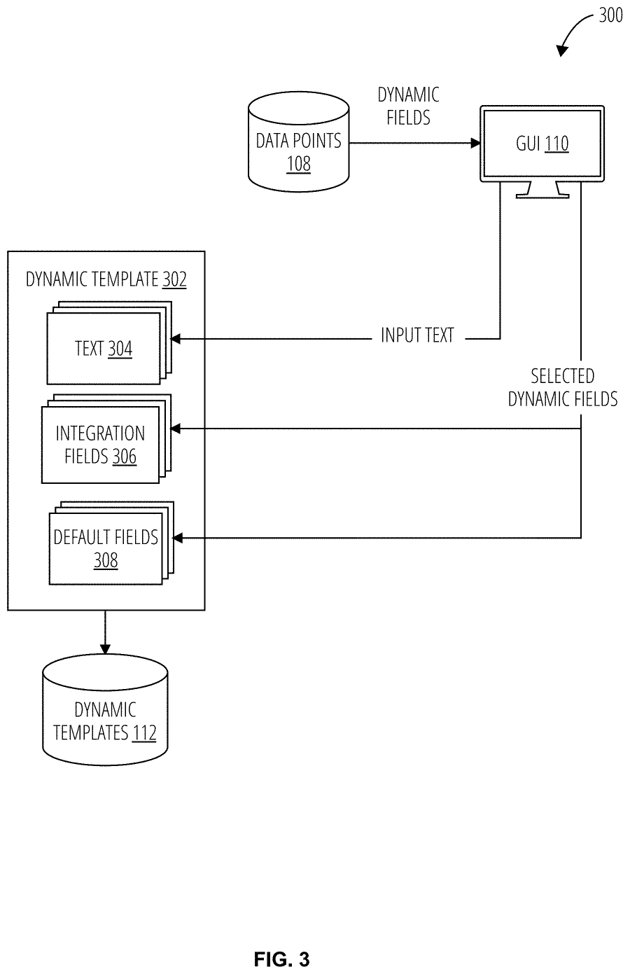

Referring to FIG. 3, a dynamic template system 300 comprises a data points control memory structure 108, a graphical user interface 110, a dynamic templates control memory structure 112, a dynamic template 302, text 304, integration fields 306, and default fields 308.

The data points control memory structure 108 stored data points from a plurality of sources. The data points stored determines the dynamic fields that populate the dynamic fields list on the graphical user interface 110. These dynamic fields may then be utilized to generate dynamic templates.

The graphical user interface 110 displays the available dynamic fields. In some embodiments, the graphical user interface 110 is configured to receive text and dynamic fields, then enrich those dynamic fields as described above. However, the graphical user interface 110 may be re-configured, such as by a user interaction, to inhibit enrichment of the message body in the message compose box or display a dynamic template generation box. The dynamic template generation box may receive text and dynamic fields without enriching the dynamic fields. The selected text and dynamic fields, along with the order of the input is then sent to the dynamic template 302.

The dynamic template 302 comprises the text 304, the integration fields 306, and the default fields 308 selected on the graphical user interface 110. The relative arrangement of the text 304, the integration fields 306, and the default fields 308 are also included in the dynamic template 302. The dynamic template 302 is then stored in the dynamic templates control memory structure 112. The dynamic template 302 is stored in an un-enriched state. The dynamic template 302 may then be displayed for selection during the current graphical user interface session and future graphical user interface sessions. The dynamic template 302 may be accessed by users associated with other user accounts. Additionally, when the dynamic template 302 is stored, the message body in the dynamic template generation box may be transferred to the message body in the message compose box, which may then be enriched and sent as a text message.

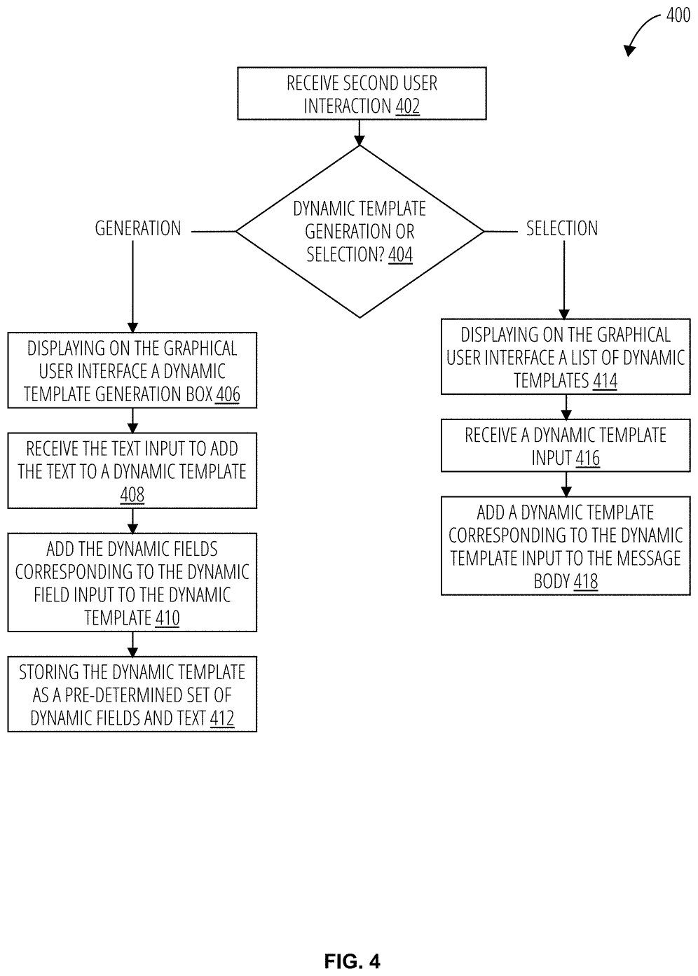

The dynamic template system 300 may be operated in accordance with the process depicted in FIG. 4.

Referring to FIG. 4, a dynamic templating method 400 receives a second user interaction (block 402). The graphical user interface may also be configured to present either dynamic template generation or selection when initiated. The dynamic templating method 400 determines whether dynamic template generation or selection was associated with the user interaction (decision block 404). If generation, a dynamic template generation box is displayed on the graphical user interface (block 406). The dynamic template generation box may be similar to the message compose box; however, the dynamic template generation box may not enrich dynamic fields. The text input is received to add the text to a dynamic template (block 408), and the dynamic fields are added corresponding to the dynamic field input to the dynamic template (block 410). The dynamic template may be received at the dynamic template generation box. The dynamic template is stored as a pre-determined set of dynamic fields and text, including the arrangement (block 412).

If a selection was associated with the user interaction, a list of dynamic templates is displayed on the graphical user interface (block 414). A dynamic template input is then received (block 416). The dynamic template corresponding to the dynamic template input is added to the message body (block 418). The message body receives the pre-determined set of dynamic fields and text. The message body may then be enriched. The list of dynamic templates may have been generated by a user account that is not associated with the user interaction.

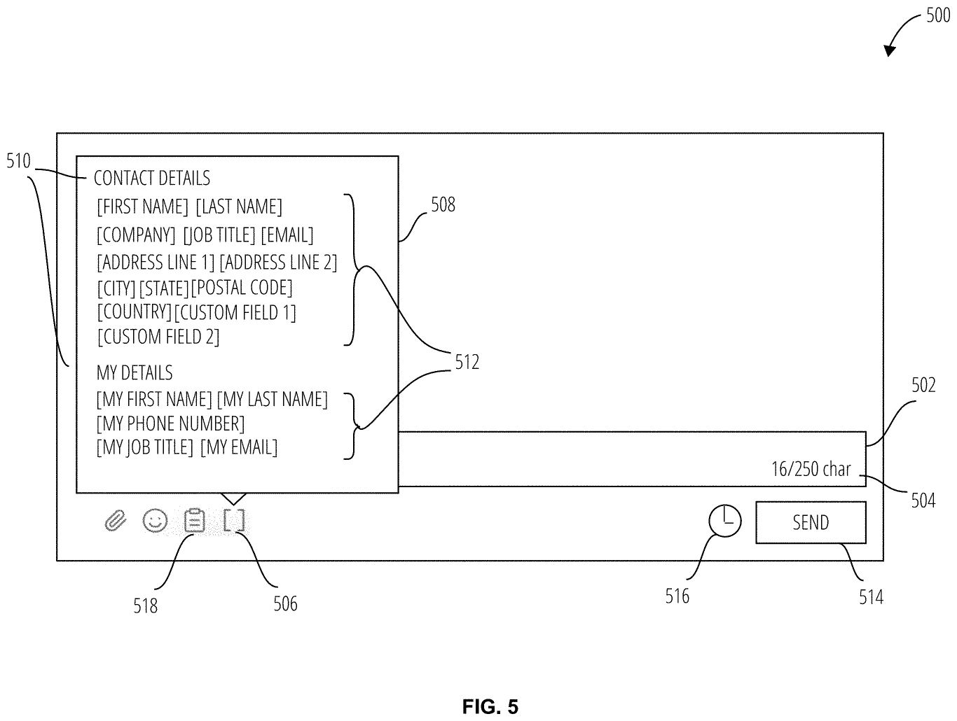

Referring to FIG. 5-FIG. 12, a graphical user interface 500 comprises a message compose box 502, a message body character indicator 504, a dynamic fields selector 506, a dynamic fields list 508, a plurality of dynamic field categories 510, dynamic fields 512, a text message generation selector 514, a status indicator 516, a dynamic template selector 518, a dynamic field input indicator 602, a message body 702, an input text 704, a dynamic fields 706, an input location indicator 708, a partially-enriched message body 802, an input text/enriched dynamic field 804, a non-enriched dynamic field 806, a non-enriched dynamic field indicator 808, an error notification 810, an enriched message body 902, a dynamic template 1002, a dynamic template generator selector 1004, a dynamic template generation box 1102, a dynamic fields 1104, a text input 1106, a dynamic template storage selector 1108, a partially-enriched message body 1202, a non-enriched dynamic field indicator 1204, and an error notification 1206. As the graphical user interface 500 receives inputs from a user, the graphical user interface 500 is altered to display the various components.

FIG. 5 depicts the graphical user interface 500 in a first state, such as a state when the graphical user interface 500 is initiated by a user interaction. The message compose box 502 is displayed and configured to receive text from a text input and dynamic fields from a dynamic field input. The message compose box 502 also comprises the message body character indicator 504 to track the number of characters in the message compose box 502. The message body character indicator 504 may be altered based on the limits placed on text messages on an SMS server.

An input may be received at the dynamic fields selector 506 to display the dynamic fields list 508. The dynamic fields list 508 comprises the plurality of dynamic field categories 510 and the dynamic fields 512 that are available. The plurality of dynamic field categories 510 have been prioritized such that the dynamic fields 512 related to the user account are located closer to the message compose box 502 than the dynamic fields 512 related to the customer account. An input at one of the dynamic fields 512 causes a dynamic field input to the message body in the message compose box 502.

The text message generation selector 514 causes the message body in the message compose box 502 to be transformed into a text message and sent to an SMS server. As depicted in later figures, the text message generation selector 514 may be configured to be inoperable based on the state of the message body, such as having a partially-enriched message body in the message compose box 502. The text message generation selector 514 may also be inoperable based on the message body exceeding a character limit, which is depicted by the message body character indicator 504.

The status indicator 516 depicts whether the graphical user interface 500 or associated components, such as the message body enrichment component, is performing a task. For example, the status indicator 516 may be animated when the message body enrichment component is enriching the message body.

The dynamic template selector 518 may be selected by an input (e.g., the second user interaction) to configure the graphical user interface 500 to display the dynamic template generator selector 1004 or the dynamic template generation box 1102.

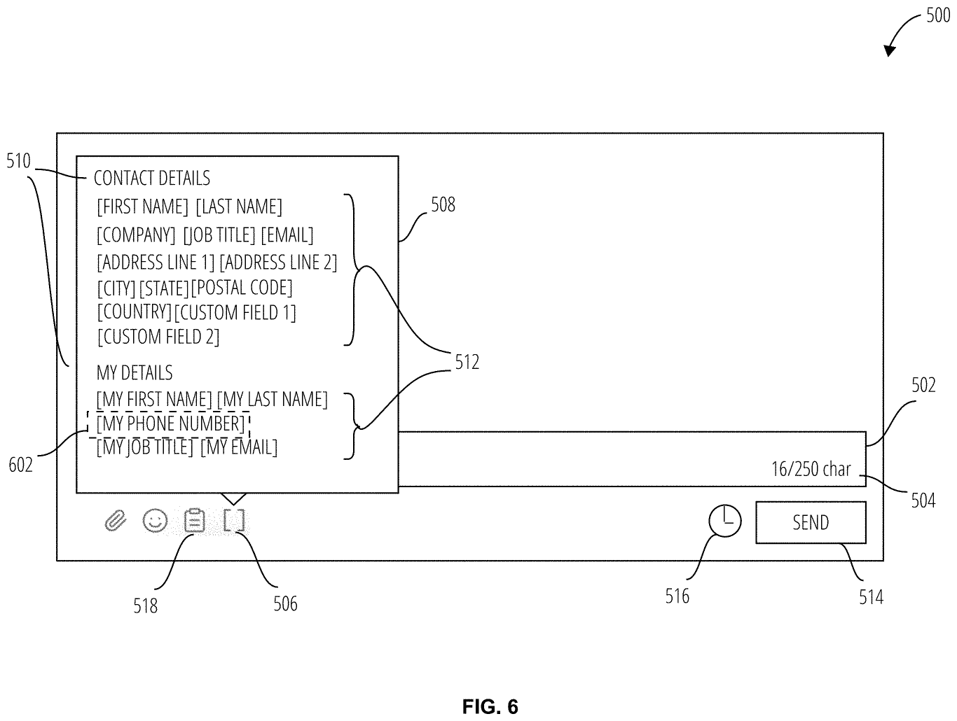

FIG. 6 depicts the graphical user interface 500 of FIG. 5 in response to a user interaction. The user interaction corresponds to an intent to select one of the dynamic fields 512. Here, [My Phone Number] has the dynamic field input indicator 602. The dynamic field input indicator 602 indicates that a dynamic field input would select the particular dynamic field that has been indicated. The dynamic field input indicator 602 may highlight, embolden, alter the color, etc. to indicate that a dynamic field input would select the dynamic field with the dynamic field input indicator 602.

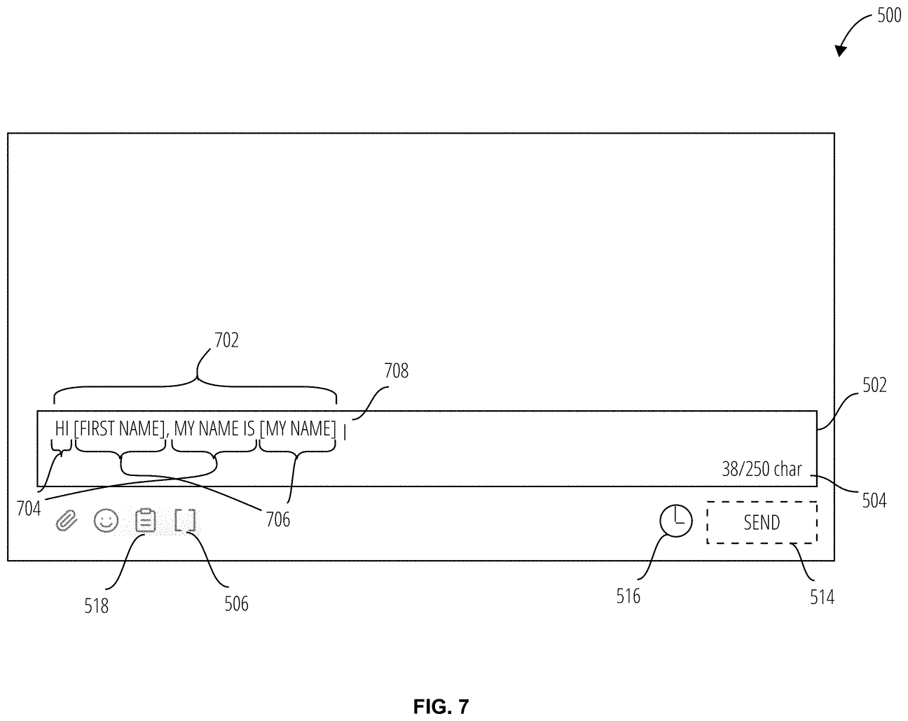

FIG. 7 depicts the graphical user interface 500 of FIG. 5 in response to receiving both text input and dynamic field input. The message compose box 502 comprises the message body 702. The message body 702 further comprises the input text 704 and the dynamic fields 706 associated with the text input and dynamic field input. The input location indicator 708 depicts the location of text or dynamic field corresponding to a next input. The input location indicator 708 may be re-located within the message compose box 502 by an input to the graphical user interface 500. The message body character indicator 504 has been updated to depict the current number of characters. The text message generation selector 514 has been configured to be inoperable in response to the message body 702 comprising non-enriched dynamic fields, that is the dynamic fields 706.

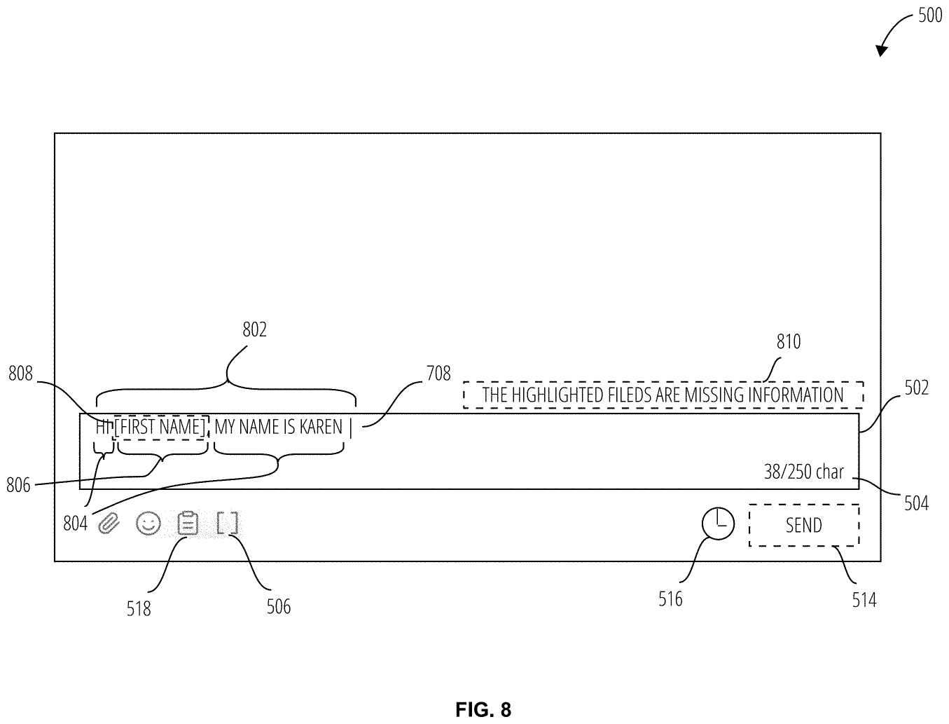

FIG. 8 depicts the graphical user interface 500 of FIG. 7 in response to an embodiment of message body enrichment. The message compose box 502 now comprises the partially-enriched message body 802. The partially-enriched message body 802 further comprises the non-enriched dynamic field 806, the input text/enriched dynamic field 804, and the non-enriched dynamic field indicator 808. The input text/enriched dynamic field 804 resulted from both the original input text 704 and one of the dynamic fields 706 that was enriched. The non-enriched dynamic field 806, however, may not have had a corresponding data point and was not enriched. The non-enriched dynamic field indicator 808 alters the non-enriched dynamic field 806 to alert a user that the non-enriched dynamic field 806 was not enriched. The non-enriched dynamic field indicator 808 may highlight, embolden, alter the color, etc. to depict the error. The error notification 810 may provide further information to the user. The error notification 810 may have a similar appearance to the non-enriched dynamic field 806 with the non-enriched dynamic field indicator 808. For example, by having similar highlight, boldness, or color. The message body character indicator 504 is updated to depict the new character total. The text message generation selector 514 remains in an inoperable state due to the non-enriched dynamic field 806 in the message compose box 502.

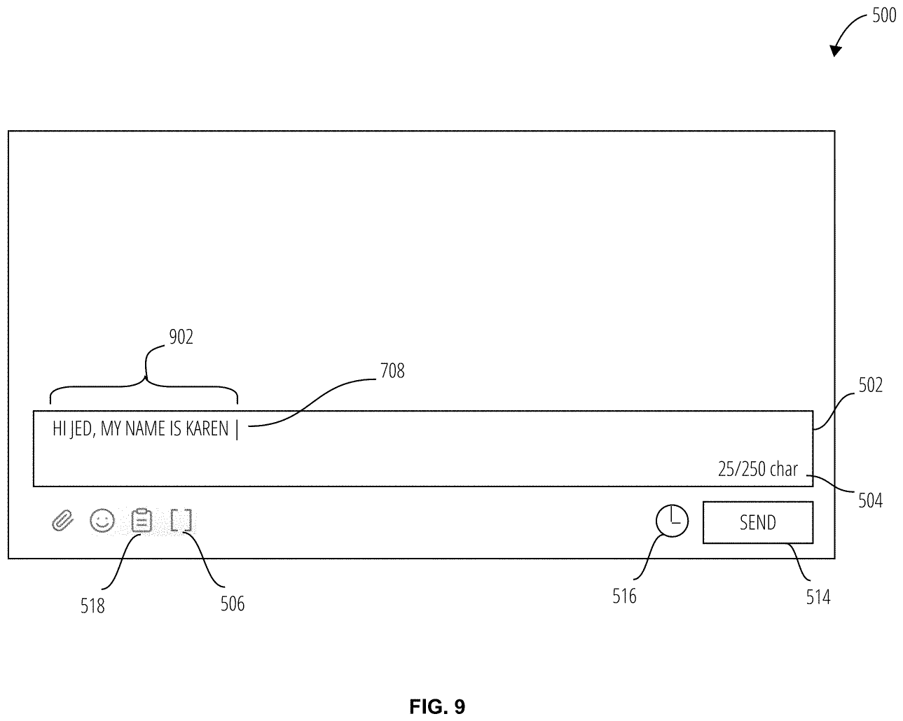

FIG. 9 depicts the graphical user interface 500 of FIG. 7 or FIG. 8 after enrichment of the message body 702 or the partially-enriched message body 802. The message compose box 502 comprises the enriched message body 902. Each of the dynamic fields 706 and non-enriched dynamic field 806 may have been enriched, or text may have been received by a text input to replace the dynamic fields 706 or the non-enriched dynamic field 806 in the message body. The message body character indicator 504 is updated to indicate the new character total. The text message generation selector 514 is configured to be made operable to send a control signal to transform the enriched message body 902 into a text message.

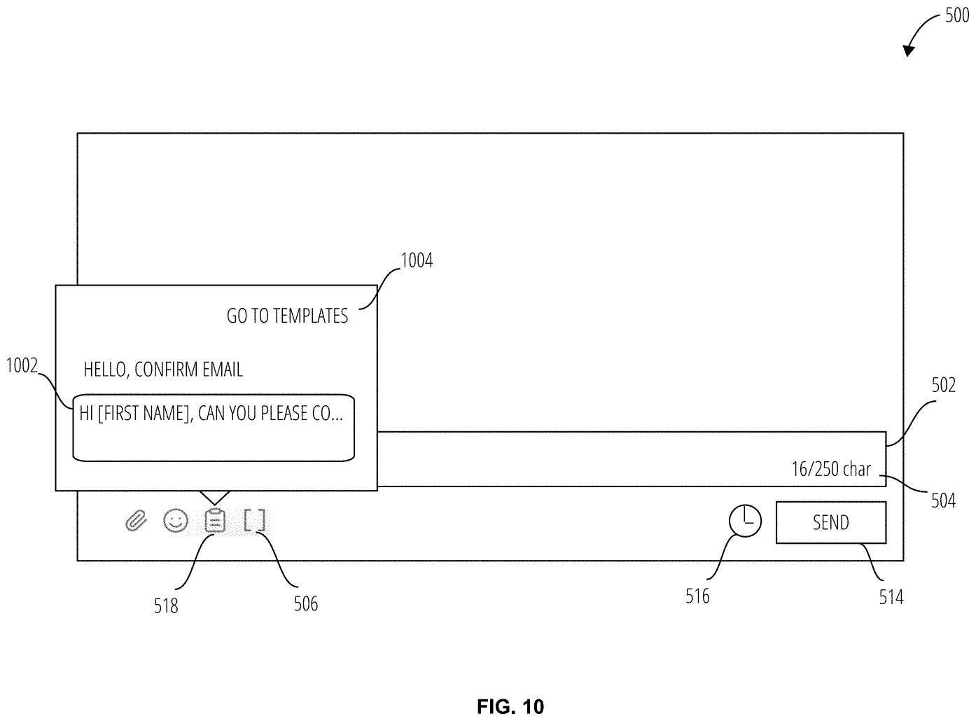

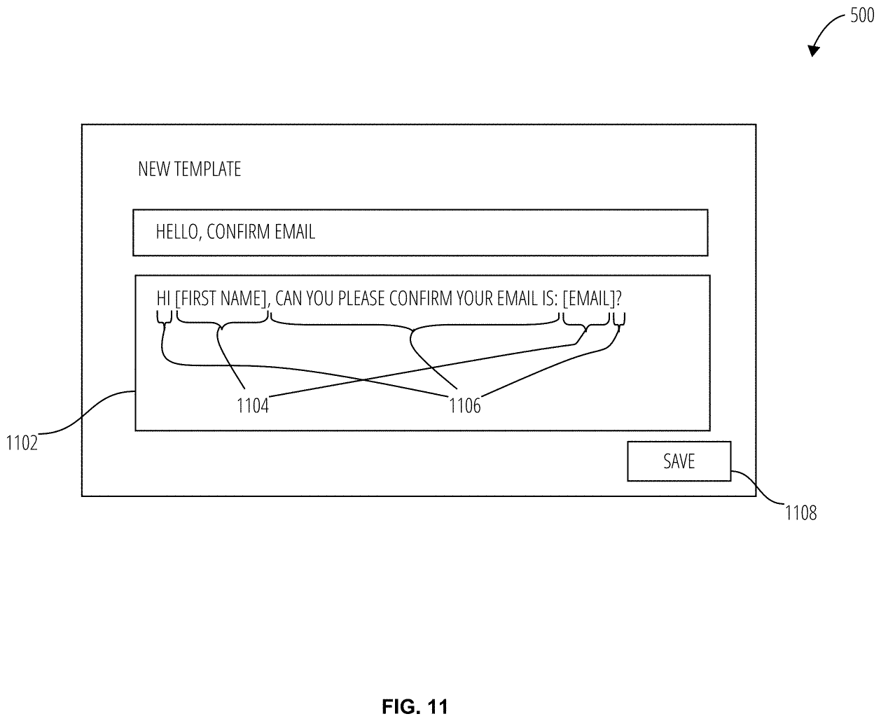

FIG. 10 depicts the graphical user interface 500 of FIG. 5 after an input is received at the dynamic template selector 518. The graphical user interface 500 is configured to display a list of dynamic templates. The list of dynamic templates includes the dynamic template 1002. The list of dynamic templates may be retrieved from a dynamic templates control memory structure. The dynamic templates retrieved and displayed may be based on the user account operating the graphical user interface 500 and may include dynamic templates generated by the user account or dynamic templates generated by another user account. A filter may be utilized to display dynamic templates that do not comprise dynamic fields that the user account is not associated. For example, a dynamic template that comprises a dynamic field for Salesforce ID may not be displayed for a user account without that software integration. The dynamic fields list may be utilized as the filter. The graphical user interface 500 may receive an input at the dynamic template 1002 and add the text and/or dynamic fields associated with the dynamic template 1002 to the message body in the message compose box 502. The message body is then enriched into an enriched message body 902. The dynamic template generator selector 1004 may also receive an input to configure the graphical user interface 500 into the graphical user interface 500 depicted in FIG. 11. In another embodiment, the graphical user interface 500 may be configured to locate the dynamic template generator selector 1004 to be accessed without an input to the dynamic template selector 518.

FIG. 11 depicts the graphical user interface 500 of FIG. 10 after an input is received at the dynamic template generator selector 1004. The graphical user interface 500 displays the dynamic template generation box 1102. The dynamic template generation box 1102 may receive the dynamic fields 1104 and the text input 1106 as a dynamic template input. The dynamic fields 1104 and the text input 1106 form the dynamic template. The dynamic template is similar to the message body; however, the dynamic template is not enriched until the dynamic template is added to the message compose box 502 as a message body, such as through the mechanism depicted in FIG. 10. The dynamic template storage selector 1108 may receive an input to store the dynamic template in the dynamic templates control memory structure. The dynamic template storage selector 1108 may also update the list of dynamic templates that may be selected with the dynamic template entered into the dynamic template generation box 1102.

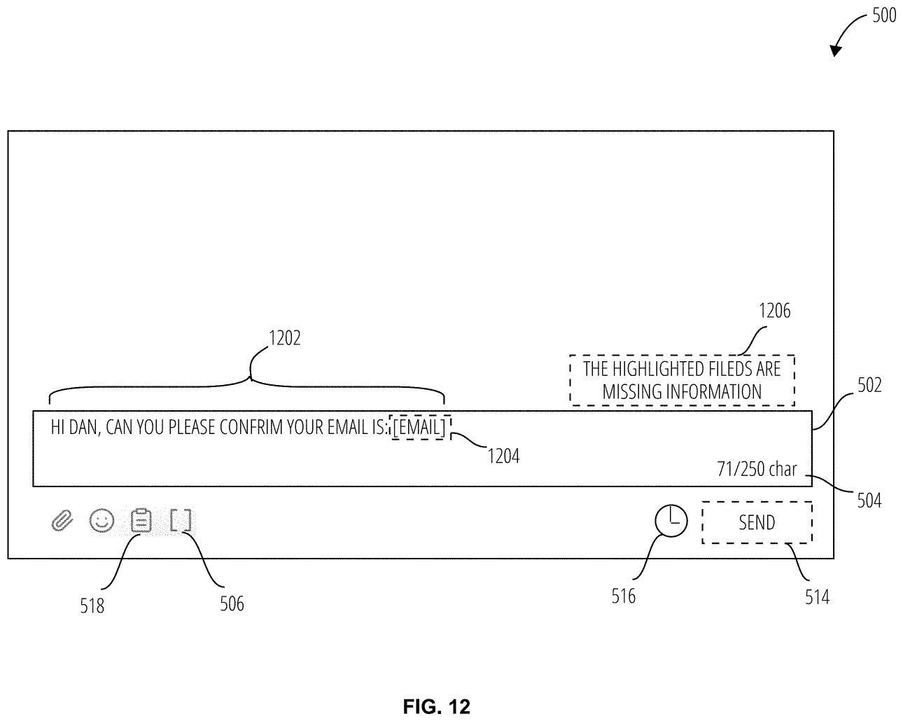

FIG. 12 depicts the graphical user interface 500 of FIG. 10 in response to the dynamic template 1002 being selected by an input. The message compose box 502 receives the dynamic template and enriches the dynamic fields in the dynamic template 1002. Here, this resulted in the partially-enriched message body 1202 as one of the dynamic fields did not have a corresponding data point. Similar to the graphical user interface 500 depicted in FIG. 8, the message compose box 502 comprises the non-enriched dynamic field indicator 1204, the graphical user interface 500 displays the error notification 1206, and the text message generation selector 514 is configured to not receive an input.

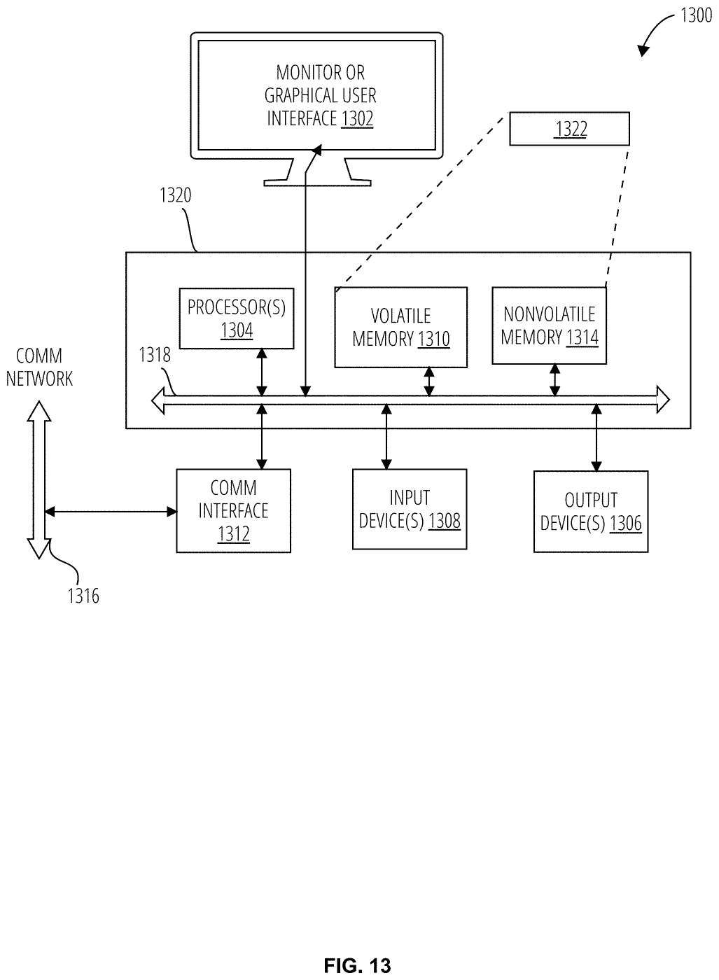

FIG. 13 is an example block diagram of a computing device 1300 that may incorporate embodiments of the present invention. FIG. 13 is merely illustrative of a machine system to carry out aspects of the technical processes described herein, and does not limit the scope of the claims. One of ordinary skill in the art would recognize other variations, modifications, and alternatives. In one embodiment, the computing device 1300 typically includes a monitor or graphical user interface 1302, a data processing system 1320, a communication network interface 1312, input device(s) 1308, output device(s) 1306, and the like.

As depicted in FIG. 13, the data processing system 1320 may include one or more processor(s) 1304 that communicate with a number of peripheral devices via a bus subsystem 1318. These peripheral devices may include input device(s) 1308, output device(s) 1306, communication network interface 1312, and a storage subsystem, such as a volatile memory 1310 and a nonvolatile memory 1314.

The volatile memory 1310 and/or the nonvolatile memory 1314 may store computer-executable instructions and thus forming logic 1322 that when applied to and executed by the processor(s) 1304 implement embodiments of the processes disclosed herein.

The input device(s) 1308 include devices and mechanisms for inputting information to the data processing system 1320. These may include a keyboard, a keypad, a touch screen incorporated into the monitor or graphical user interface 1302, audio input devices such as voice recognition systems, microphones, and other types of input devices. In various embodiments, the input device(s) 1308 may be embodied as a computer mouse, a trackball, a track pad, a joystick, wireless remote, drawing tablet, voice command system, eye tracking system, and the like. The input device(s) 1308 typically allow a user to select objects, icons, control areas, text and the like that appear on the monitor or graphical user interface 1302 via a command such as a click of a button or the like.

The output device(s) 1306 include devices and mechanisms for outputting information from the data processing system 1320. These may include the monitor or graphical user interface 1302, speakers, printers, infrared LEDs, and so on as well understood in the art.

The communication network interface 1312 provides an interface to communication networks (e.g., communication network 1316) and devices external to the data processing system 1320. The communication network interface 1312 may serve as an interface for receiving data from and transmitting data to other systems. Embodiments of the communication network interface 1312 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 1312 may be coupled to the communication network 1316 via an antenna, a cable, or the like. In some embodiments, the communication network interface 1312 may be physically integrated on a circuit board of the data processing system 1320, or in some cases may be implemented in software or firmware, such as “soft modems”, or the like.

The computing device 1300 may include logic that enables communications over a network using protocols such as HTTP, TCP/IP, RTP/RTSP, IPX, UDP and the like.

The volatile memory 1310 and the nonvolatile memory 1314 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1310 and the nonvolatile memory 1314 may be configured to store the basic programming and data constructs that provide the functionality of the disclosed processes and other embodiments thereof that fall within the scope of the present invention.

Logic 1322 that implements embodiments of the present invention may be stored in the volatile memory 1310 and/or the nonvolatile memory 1314. Said logic 1322 may be read from the volatile memory 1310 and/or nonvolatile memory 1314 and executed by the processor(s) 1304. The volatile memory 1310 and the nonvolatile memory 1314 may also provide a repository for storing data used by the logic 1322.

The volatile memory 1310 and the nonvolatile memory 1314 may include a number of memories including a main random access memory (RAM) for storage of instructions and data during program execution and a read only memory (ROM) in which read-only non-transitory instructions are stored. The volatile memory 1310 and the nonvolatile memory 1314 may include a file storage subsystem providing persistent (non-volatile) storage for program and data files. The volatile memory 1310 and the nonvolatile memory 1314 may include removable storage systems, such as removable flash memory.

The bus subsystem 1318 provides a mechanism for enabling the various components and subsystems of data processing system 1320 communicate with each other as intended. Although the communication network interface 1312 is depicted schematically as a single bus, some embodiments of the bus subsystem 1318 may utilize multiple distinct busses.

It will be readily apparent to one of ordinary skill in the art that the computing device 1300 may be a device such as a smartphone, a desktop computer, a laptop computer, a rack-mounted computer system, a computer server, or a tablet computer device. As commonly known in the art, the computing device 1300 may be implemented as a collection of multiple networked computing devices. Further, the computing device 1300 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

“data points” in this context refers to specific information that may correspond to a dynamic filed, which may represent generalized information. For example, “Smith” may be the data point for the dynamic field [Last Name].

“default fields” in this context refers to a dynamic field based on the user account or customer account.

“dynamic field” in this context refers to generalized information that may correspond to a data point, which may represent specific information. For example, “Smith” may be the data point for the dynamic field [Last Name]. The dynamic field is enriched by the data points according to the current user account and customer account contacted.

“dynamic template” in this context refers to a pre-determined arrangement or set of dynamic fields and text.

“error” in this context refers to a indication of a dynamic field not having a corresponding data point (not enriched). The error may operate the graphical user interface to alter its display for the dynamic field that is not enrich.

“graphical user interface” in this context refers to a visual way of interacting with a computer using items such as windows, icons, and menus, used by most modern operating systems.

“message body” in this context refers to an arrangement of text and dynamic fields.

“partially-enriched message body” in this context refers to a message body with a dynamic field that has not been enriched.

“SMS server” in this context refers to a computer or computer program that manages access to a centralized resource or service in a network to organize bilateral exchange with subscribers of GSM short text messages.

“text” in this context refers to alphabetic and numeric characters.

“text message” in this context refers to electronic messages, typically comprising alphabetic and numeric characters, formatted to be transmitted by a SMS server.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method comprising:
receiving data points, each of the data points associated with a dynamic fields list, the dynamic fields list comprising one or more dynamic fields;
receiving a user interaction to initiate operation of a graphical user interface;
displaying the graphical user interface in response to the user interaction comprising:
the dynamic fields list to:
display the dynamic fields; and
receive a dynamic field input at one or more of the dynamic fields; and
a message compose box to:
display a message body;
receive a text input to add text to the message body; and
in response to the dynamic field input, add the dynamic fields corresponding to the dynamic field input to the message body;
receiving the message body from the graphical user interface;
enriching the message body with the data points associated with the dynamic fields in the message body;
generating a text message from the message body enriched with the data points; and
transmitting the text message to an SMS server.

2. The method of claim 1, wherein enriching the message body with the data points associated with the dynamic fields in the message body comprises:
determining each of the dynamic fields in the message body;
substituting the data points for the dynamic fields;
determining whether one or more of the dynamic fields were not substituted;
in response to determining that one or more of the dynamic fields were not substituted:
configuring the graphical user interface to:
display a partially-enriched message body in the message compose box; and
display an error associated with the dynamic fields without a corresponding data point; and
not generating the text message from the message body.

3. The method of claim 1, further comprising:
receiving a second user interaction to alter the operation of a graphical user interface;
in response to the second user interaction, displaying on the graphical user interface a list of dynamic templates, each of the dynamic templates to:
receive a dynamic template input; and
in response to the dynamic template input, add a dynamic template corresponding to the dynamic template input to the message body, the dynamic template comprising a pre-determined set of dynamic fields and text.

4. The method of claim 3, wherein the second user interaction is associated with a first user account and the list of dynamic templates comprises one or more dynamic templates from a second user account.

5. The method of claim 1, further comprising:
receiving a second user interaction to alter the operation of a graphical user interface;
in response to the second user interaction, displaying on the graphical user interface a dynamic template generation box to:
receive the text input to add the text to a dynamic template; and
in response to the dynamic field input, add the dynamic fields corresponding to the dynamic field input to the dynamic template; and
storing the dynamic template as a pre-determined set of dynamic fields and text.

6. The method of claim 1, wherein the data points are received from integrations associated with a user account from which the user interaction was received.

7. The method of claim 1, wherein the data points are received from a user account from which the user interaction was received.

8. The method of claim 1, wherein the user interaction is associated with a customer account and the data points are received from the customer account.

9. The method of claim 1, wherein the dynamic fields are received from a plurality of sources and the dynamic fields list:
categorizes the dynamic fields based on the plurality of sources into a plurality of dynamic field categories; and
determines a priority for each of the plurality of dynamic field categories, the plurality of dynamic field categories being placed on the graphical user interface according to the priority.

10. The method of claim 1, further comprising, in response to the text input or the dynamic field input, adding an additional dynamic field to the message body.

11. A computing apparatus, the computing apparatus comprising:
a processor; and
a memory storing instructions that, when executed by the processor, configure the apparatus to:
receive data points, each of the data points associated with a dynamic fields list, the dynamic fields list comprising one or more dynamic fields;
receive a user interaction to initiate operation of a graphical user interface;
display the graphical user interface in response to the user interaction comprising:
a dynamic fields list to:
display the dynamic fields; and
receive a dynamic field input at one or more of the dynamic fields; and
a message compose box to:
display a message body;
receive a text input to add text to the message body; and
in response to the dynamic field input, add the dynamic fields corresponding to the dynamic field input to the message body;
receive the message body from the graphical user interface;
enrich the message body with the data points associated with the dynamic fields in the message body;
generate a text message from the message body enriched with the data points; and
transmit the text message to an SMS server.

12. The computing apparatus of claim 11, wherein enriching the message body with the data points associated with the dynamic fields in the message body comprises:
determine each of the dynamic fields in the message body;
substitute the data points for the dynamic fields;
determine whether one or more of the dynamic fields were not substituted;
in response to determining that one or more of the dynamic fields were not substituted:
configure the graphical user interface to:
display a partially-enriched message body in the message compose box; and
display an error associated with the dynamic fields without the corresponding data point; and
not generate the text message from the message body.

13. The computing apparatus of claim 11, wherein the instructions further configure the apparatus to:
receive a second user interaction to alter the operation of a graphical user interface;
in response to the second user interaction, display on the graphical user interface a list of dynamic templates, each of the dynamic templates to:
receive a dynamic template input; and
in response to the dynamic template input, add a dynamic template corresponding to the dynamic template input to the message body, the dynamic template comprising a pre-determined set of dynamic fields and text.

14. The computing apparatus of claim 13, wherein the second user interaction is associated with a first user account and the list of dynamic templates comprises one or more dynamic templates from a second user account.

15. The computing apparatus of claim 11, wherein the instructions further configure the apparatus to:
receive a second user interaction to alter the operation of a graphical user interface;
in response to the second user interaction, display on the graphical user interface a dynamic template generation box to:
receive the text input to add the text to a dynamic template; and
in response to the dynamic field input, add the dynamic fields corresponding to the dynamic field input to the dynamic template; and
store the dynamic template as a pre-determined set of dynamic fields and text.

16. The computing apparatus of claim 11, wherein the data points are received from integrations associated with a user account from which the user interaction was received.

17. The computing apparatus of claim 11, wherein the data points are received from a user account from which the user interaction was received.

18. The computing apparatus of claim 11, wherein the user interaction is associated with a customer account and the data points are received from the customer account.

19. The computing apparatus of claim 11, wherein the dynamic fields are received from a plurality of sources and the dynamic fields list:
categorizes the dynamic fields based on the plurality of sources into a plurality of dynamic field categories; and
determines a priority for each of the plurality of dynamic field categories, the plurality of dynamic field categories being placed on the graphical user interface according to the priority.

20. The computing apparatus of claim 11, wherein the instructions further configure the apparatus to, in response to the text input or the dynamic field input, adding an additional dynamic field to the message body.
